(19) United States
(12) Patent Application Publication
(10) Pub. No.: US 2025/0187475 A1
(43) Pub. Date: Jun. 12, 2025

(54) AUTOMATIC TUNING SYSTEM AND METHOD FOR VEHICLE CHARGING PARAMETERS

(71) Applicant: HYUNDAI AUTOEVER CORP., Seoul (KR)

(72) Inventors: JaeHyun LIM, Seoul (KR); KyungTaek KIM, Seoul (KR); SungJin CHOI, Seoul (KR)

(21) Appl. No.: 18/940,236

(22) Filed: Nov. 7, 2024

(30) Foreign Application Priority Data
Dec. 12, 2023 (KR) 10-2023-0180120

(51) Int. Cl. B60L 53/62; B60L 53/30

(52) U.S. Cl. CPC B60L 53/62; B60L 53/305

(57) ABSTRACT

Automatic tuning systems and methods for vehicle charging parameters are described. According to one embodiment, a system comprises a vehicle charging module configured to perform charging of a vehicle according to parameter values set in symbols related to the charging and an external charger configured to communicate with the vehicle charging module to perform charging and to automatically tune the parameter values set in the symbols related to the charging.

### CROSS-REFERENCE TO RELATED APPLICATION

This application claims priority from and the benefit of Korean Patent Application No. 10-2023-0180120, filed on Dec. 12, 2023, which is hereby incorporated by reference for all purposes as if set forth herein.

### BACKGROUND OF THE INVENTION

### Field

Exemplary embodiments according to the present disclosure relate to an automatic tuning system and method for vehicle charging parameters, which enable an authenticated external charger to automatically tune parameters of a vehicle charging module.

### Discussion of the Background

In general, a vehicle diagnoses state thereof at a charging station, measures the strength of a signal transmitted from a charger (i.e., an external charger) at the charging station, and based on these measurements, the vehicle tunes parameters of a vehicle charging module (i.e., the parameters set for driving the charging module) to align with the characteristics of the external charger providing the charging current.

In this case, given the vehicle's limited resources, it is practically impossible to automatically tune the internal parameters of the vehicle charging module in response to the characteristics of various external chargers. Even if there is an external charger capable of high-performance computation, there is no protocol (e.g., app authentication procedures, app communication standards, app communication data settings, etc., for parameter tuning) for tuning the parameters of the vehicle charging module (i.e., the parameters set for driving the charging module).

In addition, since each vehicle has a different wireless communication module implemented differently, the charging station (i.e., external charger) is unable to have any direct influence on the state of a controller in the vehicle.

Accordingly, based on the XCP (Universal Measurement and Calibration Protocol) standard and the transmission and reception of an A2L file (i.e., a file with the A2L extension that refers to the ASAP2 (ASAM MCD-2 MC) ECU description file, there is a need for technology that uses only standardized parameter symbols to translate into the addresses of the corresponding variables, thus enabling the control of the slave (e.g., the vehicle), without altering the Application Software (ASW) logic. (For reference, the master corresponds to the charging station, i.e., the external charger.)

The related art of the present disclosure is disclosed in Korean Patent Application Publication No. 10-2020-0107614 (published on Sep. 16, 2020).

### BRIEF SUMMARY

Exemplary embodiments according to an aspect of the present disclosure are directed to providing an automatic tuning system and method for vehicle charging parameters, which enable an authenticated external charger to automatically tune parameters of a vehicle charging module.

An automatic tuning system for vehicle charging parameters according to an aspect of the present disclosure includes a vehicle charging module configured to perform charging of a vehicle according to parameter values set in symbols related to the charging, and an external charger configured to communicate with the vehicle charging module to perform charging and to automatically tune the parameter values set in the symbols related to the charging.

In an embodiment, the vehicle charging module includes an XCP (Universal Measurement and Calibration Protocol) module to read or modify the parameter values at addresses of the symbols related to the charging.

In an embodiment, the external charger, as a master, performs a process of reading and modifying the parameter values written in the symbol addresses of the vehicle charging module, as a slave, using XCP protocol at least once and tunes the parameter values for the symbols of the vehicle charging module.

In an embodiment, the external charger performs secure authentication with the vehicle charging module using XCP communication to tune the parameter values for the symbols of the vehicle charging module.

In an embodiment, to perform secure authentication for using the XCP communication, the vehicle charging module has a public key of the external charger and the external charger has a private key for an external charger.

In an embodiment, to tune the parameter values for the symbols of the vehicle charging module, the external charger receives a file that includes address information for the symbols related to the charging from the vehicle charging module, performs tamper verification, and compares a symbol table of the vehicle charging module included in the received file with an internal symbol table stored within the external charger.

In an embodiment, before tuning the parameter values for the symbols of the vehicle charging module, the vehicle charging module and the external charger perform a process of reading a parameter value at a test symbol address to verify if tuning is possible.

In an embodiment, the operation of the external charger for automatic tuning of vehicle charging parameters is implemented by a server or cloud computing system.

An automatic tuning method for vehicle charging parameters according to another aspect of the present disclosure includes charging, by a vehicle charging module, a vehicle according to parameter values set in symbols related to the charging when the vehicle enters a charging station to perform charging and automatically tuning, by an external charger which communicates with the vehicle charging module to perform charging, the parameter values set in the symbols related to the charging to improve charging efficiency.

In an embodiment, the vehicle charging module includes an XCP (Universal Measurement and Calibration Protocol) module to read or modify the parameter values at addresses of the symbols related to the charging.

In an embodiment, in the automatically tuning of the parameter values set in the symbols related to the charging, the external charger, as a master, performs a process of reading and modifying the parameter values written in the symbol addresses of the vehicle charging module, as a slave, using XCP protocol at least once and tunes the parameter values for the symbols of the vehicle charging module.

In an embodiment, to tune the parameter values for the symbols of the vehicle charging module, the external charger performs secure authentication with the vehicle charging module using XCP communication.

In an embodiment, to perform secure authentication for using the XCP communication, the vehicle charging module has a public key of the external charger and the external charger has a private key for an external charger.

In an embodiment, to tune the parameter values for the symbols of the vehicle charging module, the external charger receives a file that includes address information for the symbols related to the charging from the vehicle charging module, performs tamper verification, and compares a symbol table of the vehicle charging module included in the received file with an internal symbol table stored within the external charger.

In an embodiment, before tuning the parameter values for the symbols of the vehicle charging module, the vehicle charging module and the external charger perform a process of reading a parameter value at a test symbol address to verify if tuning is possible.

In an embodiment, the operation of the external charger for automatic tuning of vehicle charging parameters is implemented by a server or cloud computing system.

An automatic tuning method for vehicle charging parameters according to yet another aspect of the present disclosure includes automatically tuning, by an external charger which communicates with a vehicle charging module to perform charging, parameter values set in symbols related to the charging to improve charging efficiency, wherein the vehicle charging module performs charging according to the parameter values set in the symbols related to the charging, and the external charger, as a master, performs a process of reading and modifying the parameter values written in the symbol addresses of the vehicle charging module, as a slave, using XCP protocol at least once and tunes the parameter values for the symbols of the vehicle charging module.

According to an aspect of the present disclosure, the automatic tuning system and method for vehicle charging parameters enable the authenticated external charger to automatically tune the parameters of the vehicle charging module.

### BRIEF DESCRIPTION OF THE DRAWINGS

FIG. 1 is an illustrative diagram showing a schematic configuration of an automatic tuning system for vehicle charging parameters according to an embodiment of the present disclosure.

FIG. 2 is a flowchart describing an automatic tuning method for vehicle charging parameters according to an embodiment of the present disclosure.

FIGS. 3A and 3B are illustrative diagrams showing a situation in which vehicle charging is performed at a charging station where an automatic tuning system for vehicle charging parameters, according to an embodiment of the present disclosure, is applied.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

An embodiment of an automatic tuning system and method for vehicle charging parameters according to the present disclosure will be described hereinafter with reference to the accompanying drawings.

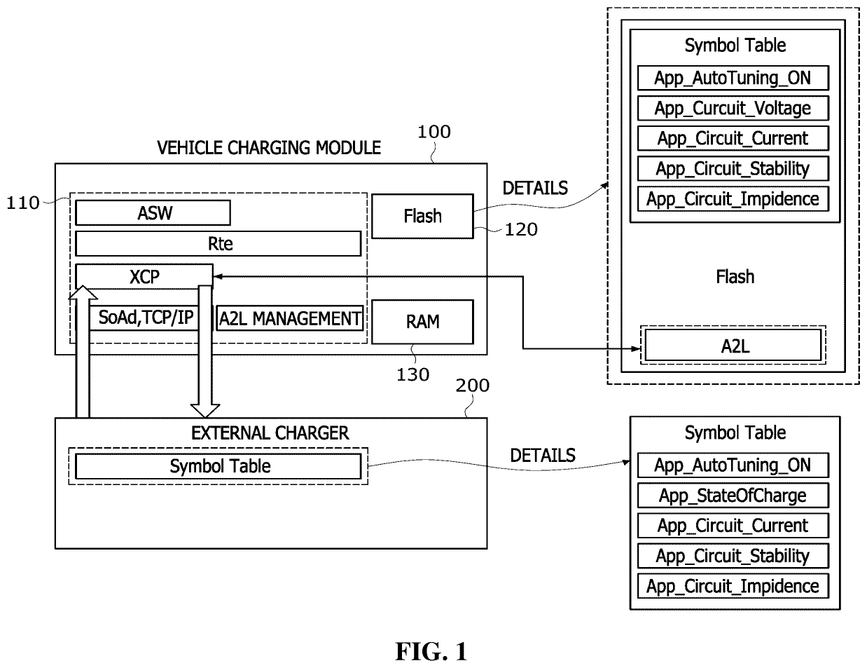

FIG. 1 is an illustrative diagram showing a schematic configuration of an automatic tuning system for vehicle charging parameters according to an embodiment of the present disclosure.

As shown in FIG. 1, the automatic tuning system for vehicle charging parameters according to the embodiment includes a vehicle charging module 100 and an external charger 200. The operation of the external charger 200 for automatic tuning of vehicle charging parameters may be implemented by a processor or microcomputer included within the external charger 200 or implemented by a server or cloud computing system.

The vehicle charging module 100 includes a control module 110, flash memory 120, and RAM 130.

The control module 110 may include at least an XCP (Universal Measurement and Calibration Protocol) module (which performs operations to read or write values (variables) at addresses of symbols in the embodiment), and an A2L (i.e., a file with an A2L extension, which includes address information for the symbols in the embodiment) management module (e.g., CDD).

In addition, the control module 110 may include application software (ASW) parameters configured using a standardized symbol table, while no logic is configured in the ASW for tuning the parameters. In other words, for tuning of the parameter values of the symbols in the embodiment, the external charger 200, the master, is configured to read and modify (tune) the values (variables or parameter values) written in the corresponding symbol addresses of the vehicle charging module 100, the slave, using the XCP protocol.

In addition, the control module 110 may include an additional communication module (e.g., SoAd, Socket Adapter, TCP/IP, Transmission Control Protocol/Internet Protocol). For secure authentication, the vehicle charging module 100 has a public key of the external charger 200.

The external charger 200 has a private key for an external charger.

The vehicle charging module 100 and the external charger 200 perform secure authentication (e.g., secure authentication to perform communications using the XCP protocol) with each other.

The external charger 200 receives an A2L file (a file that includes address information for symbols related to vehicle charging in the embodiment), performs signature verification (i.e., tamper verification), and compares the symbol table of the vehicle charging module 100 included in the A2L file with an internal symbol table stored within the external charger 200. The external charger 200 determines an address of a symbol in the symbol table of the vehicle charging module 100 that requires parameter modification, and modifies the value (variable or parameter value) at the address of that symbol. In other words, the external charger 200 modifies (tunes) the parameter value of the symbol. In this case, the external charger 200 may use the XCP protocol to modify (tune) the parameter value of a specific symbol.

The external charger 200 checks the A2L file for data (i.e., the parameter value) required for performing tuning logic and requests the vehicle charging module 100 to read (measure) the value at the corresponding symbol address in order to modify the value (variable or parameter value) at the corresponding symbol address.

In this case, the external charger 200 serves as the master and the vehicle charging module 100 serves as the slave.

The external charger 200 requests and receives response data from the vehicle charging module 100. Based on this data, the external charger 200 finds an optimal value through computation (e.g., deep learning or mathematical algorithms) or a specified lookup table (not shown) and requests calibration from the vehicle charging module 100.

In this case, the process of reading (measuring) the parameter value (or variable value) at the corresponding symbol address and modifying and applying (calibrating) the parameter value (or variable value) at the corresponding symbol address may be performed at least once in order to apply an optimal parameter value (or variable value).

In other words, the vehicle charging module 100 is limited in performing its own logic for optimal vehicle charging due to resource constraints caused by the characteristics of devices configured in the vehicle and safety considerations.

Accordingly, the embodiment allows the application of an optimal parameter value to the vehicle charging module 100 by a process of reading and modifying a parameter value (or variable value) at a specific symbol address through the securely authenticated external charger 200.

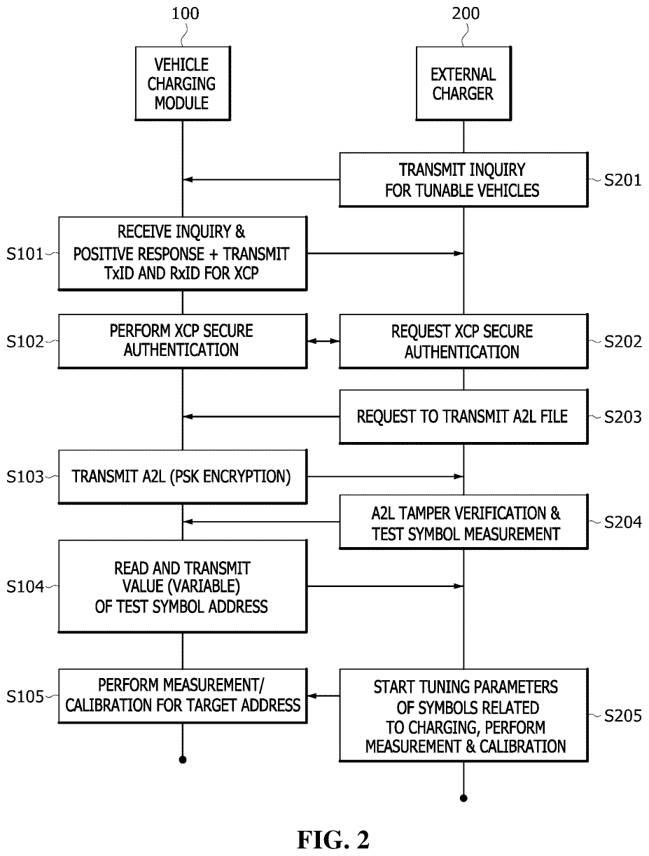

FIG. 2 is a flowchart describing an automatic tuning method for vehicle charging parameters according to an embodiment of the present disclosure.

Referring to FIG. 2, when a vehicle enters a charging station to perform charging, the external charger 200 transmits an inquiry to the vehicle charging module 100 of the vehicle to determine whether the vehicle is a tunable vehicle (i.e., a vehicle in which the external charger is tunable to symbols of the vehicle charging module using XCP communication) (S201). The operation of the external charger 200 for automatic tuning of vehicle charging parameters may be implemented by a processor or microcomputer included within the external charger 200 or may be implemented by a server or cloud computing system.

In the case of the tunable vehicle (i.e., a vehicle in which the external charger is tunable to symbols of the vehicle charging module using XCP communication), the vehicle charging module 100, upon receiving the inquiry from the external charger 200, transmits an ID (Tx ID and Rx ID) for XCP communication (i.e., communication using the XCP protocol) to the external charger 200 with a positive response (S101).

Thereafter, the vehicle charging module 100 and the external charger 200 perform a secure authentication process for XCP communication (e.g., secure authentication request and secure authentication execution for XCP communication) with each other according to a predetermined procedure (S202, S102).

Once the XCP authentication between the vehicle charging module 100 and the external charger 200 is completed, the external charger 200 requests the vehicle charging module 100 to transmit an A2L file (a file that includes address information for symbols related to vehicle charging in the embodiment) (S203).

Upon receiving the request for the A2L file from the external charger 200, the vehicle charging module 100 performs encryption (e.g., PSK encryption) on the A2L file and transmits the resulting A2L file to the external charger 200 (S103).

After receiving the A2L file from the vehicle charging module 100, the external charger 200 performs tamper verification of the A2L file and instructs (requests) the vehicle charging module 100 to read (perform a test symbol measurement) a value (variable or parameter value) at a specified test symbol address (S204).

Upon being instructed (requested) to read (perform a test symbol measurement) the value (variable or parameter value) at the specified test symbol address, the vehicle charging module 100 reads the value (variable or parameter value) at the specified test symbol address and transmits the value to the external charger 200 (S104).

After receiving the value (variable or parameter value) at the specified test symbol address from the vehicle charging module 100, the external charger 200 determines that normal parameter tuning is possible and initiates parameter tuning of the charging-related symbols of the vehicle charging module 100. This involves a process of reading (measuring) the parameter value (or variable value) at each symbol address required for tuning through interaction with the vehicle charging module 100 using XCP communication, and modifying and applying (calibrating) the parameter value (or variable value) at the corresponding symbol address (S105, S205).

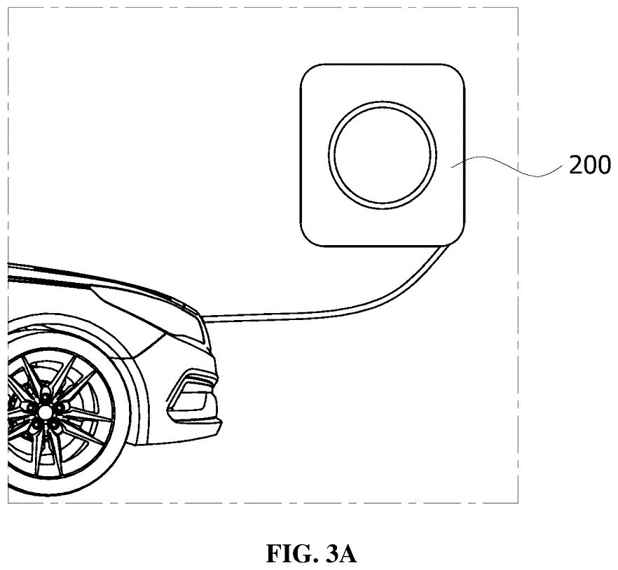

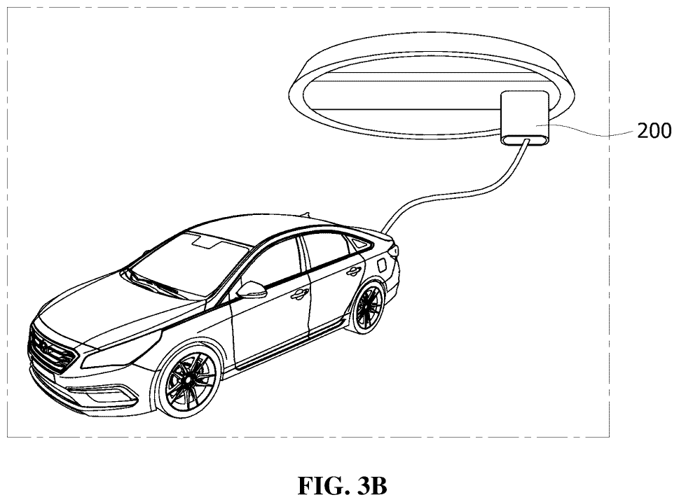

FIGS. 3A and 3B are illustrative diagrams showing a situation in which vehicle charging is performed at a charging station where an automatic tuning system for vehicle charging parameters, according to an embodiment of the present disclosure, is applied. The external charger 200 may reduce load on the vehicle by directly performing the tuning of symbols related to the charging of the vehicle charging module 100.

Furthermore, when the vehicle charging module 100 is used to perform parameter tuning, this module is unable to be used unless pre-programmed for a specific charging method, thus making it incompatible with new types of chargers, such as rapid chargers. However, the method according to the present disclosure allows the parameter values of the symbols related to the charging of the vehicle charging module 100 to be tuned to align with the method adapted to the external charger 200 in order to enable the external charger 200 to perform optimal charging according to the method adapted thereto.

Accordingly, the embodiment of the present disclosure addresses the issue that the vehicle charging module 100 configured in the vehicle is unable to perform parameter tuning for optimal vehicle charging on its own due to the characteristics thereof. This enables automatic tuning of the parameter values of the symbols related to the charging of the vehicle charging module 100 through the securely authenticated external charger 200, thereby improving the charging efficiency of the vehicle.

What is claimed is:

1. An automatic tuning system for vehicle charging parameters, the automatic tuning system comprising:
a vehicle charging module configured to perform charging of a vehicle according to parameter values set in symbols related to the charging; and
an external charger configured to communicate with the vehicle charging module to perform charging and to automatically tune the parameter values set in the symbols related to the charging.

2. The automatic tuning system of claim 1, wherein the vehicle charging module includes a Universal Measurement and Calibration Protocol (XCP) module to read or modify the parameter values at addresses of the symbols related to the charging.

3. The automatic tuning system of claim 1, wherein the external charger, as a master, performs a process of reading and modifying the parameter values written in symbol addresses of the vehicle charging module, as a slave, using an XCP protocol at least once and tunes the parameter values set in the symbols related to the charging.

4. The automatic tuning system of claim 1, wherein the external charger performs a secure authentication with the vehicle charging module to tune the parameter values set in the symbols related to the charging using an XCP communication.

5. The automatic tuning system of claim 4, wherein, to perform the secure authentication for using the XCP communication, the vehicle charging module includes a public key of the external charger and the external charger has a private key.

6. The automatic tuning system of claim 1, wherein, to tune the parameter values set in the symbols related to the charging, the external charger receives a file that includes address information for the symbols related to the charging from the vehicle charging module, performs a tamper verification, and compares a symbol table of the vehicle charging module included in the file with an internal symbol table stored within the external charger.

7. The automatic tuning system of claim 1, wherein, before tuning the parameter values set in the symbols related to the charging, the vehicle charging module and the external charger perform a process of reading a parameter value at a test symbol address to verify if a tuning is possible.

8. The automatic tuning system of claim 1, wherein an operation of the external charger for automatic tuning of the parameter values is implemented by a server or a cloud computing system.

9. An automatic tuning method for vehicle charging parameters, the automatic tuning method comprising:
charging, by a vehicle charging module, a vehicle according to parameter values set in symbols related to the charging when the vehicle enters a charging station to perform the charging; and
automatically tuning, by an external charger which communicates with the vehicle charging module to perform the charging, the parameter values set in the symbols related to the charging to improve a charging efficiency.

10. The automatic tuning method of claim 9, wherein the vehicle charging module includes an XCP module to read or modify the parameter values at addresses of the symbols related to the charging.

11. The automatic tuning method of claim 9, wherein, in the automatically tuning of the parameter values set in the symbols related to the charging, the external charger, as a master, performs a process of reading and modifying the parameter values written in symbol addresses of the vehicle charging module, as a slave, using an XCP protocol at least once and tunes the parameter values for the symbols of the vehicle charging module.

12. The automatic tuning method of claim 9, wherein, to tune the parameter values set in the symbols related to the charging, the external charger performs a secure authentication with the vehicle charging module using an XCP communication.

13. The automatic tuning method of claim 12, wherein, to perform the secure authentication for using the XCP communication, the vehicle charging module includes a public key of the external charger and the external charger has a private key.

14. The automatic tuning method of claim 9, wherein, to tune the parameter values set in the symbols related to the charging, the external charger receives a file that includes address information for the symbols related to the charging from the vehicle charging module, performs a tamper verification, and compares a symbol table of the vehicle charging module included in the file with an internal symbol table stored within the external charger.

15. The automatic tuning method of claim 9, wherein, before tuning the parameter values set in the symbols related to the charging, the vehicle charging module and the external charger perform a process of reading a parameter value at a test symbol address to verify if a tuning is possible.

16. The automatic tuning method of claim 9, wherein an operation of the external charger for automatic tuning of the parameter values is implemented by a server or a cloud computing system.

17. An automatic tuning method for vehicle charging parameters, the automatic tuning method comprising:
automatically tuning, by an external charger which communicates with a vehicle charging module to perform charging, parameter values set in symbols related to the charging to improve a charging efficiency, wherein the vehicle charging module performs the charging according to the parameter values set in the symbols related to the charging, and the external charger, as a master, performs a process of reading and modifying the parameter values written in symbol addresses of the vehicle charging module, as a slave, using an XCP protocol at least once and tunes the parameter values set in the symbols related to the charging.

18. The automatic tuning method of claim 17, wherein, to tune the parameter values set in the symbols related to the charging, the external charger performs a secure authentication with the vehicle charging module using an XCP communication.

19. The automatic tuning method of claim 18, wherein, to perform the secure authentication for using the XCP communication, the vehicle charging module includes a public key of the external charger and the external charger has a private key.

20. The automatic tuning method of claim 17, wherein, to tune the parameter values set in the symbols related to the charging, the external charger receives a file that includes address information for the symbols related to the charging from the vehicle charging module, performs a tamper verification, and compares a symbol table of the vehicle charging module included in the file with an internal symbol table stored within the external charger.
